(19) United States
(12) Patent Application Publication
(10) Pub. No.: US 2025/0087916 A1
(43) Pub. Date: Mar. 13, 2025

(54) CARD EDGE CONNECTOR AND CONDUCTIVE TERMINAL

(71) Applicant: BELLWETHER ELECTRONIC CORP., Taoyuan City (TW)

(72) Inventor: Chia-Hung Kuo, New Taipei City (TW)

(21) Appl. No.: 18/784,885

(22) Filed: Jul. 25, 2024

Related U.S. Application Data
(60) Provisional application No. 63/537,853, filed on Sep. 12, 2023.

(51) Int. Cl. H01R 12/72; H01R 12/70; H01R 13/115; H01R 13/629

(52) U.S. Cl. CPC H01R 12/721; H01R 12/7023; H01R 13/115; H01R 13/62933

(57) ABSTRACT

A card edge connector includes an insulative housing and a plurality of first conductive terminals. The insulative housing includes a plurality of first retaining grooves and a docking socket. Each of the first retaining grooves includes a tongue portion therein. The plurality of first conductive terminals are inserted into the plurality of first retaining grooves, respectively. A part of each of the first conductive terminals forms a U-shaped section, and an inner lower edge of the U-shaped section includes a hook portion. The tongue portion extends into an opening of the U-shaped section, the hook portion abuts against a lower surface of the tongue portion, and an upper surface of the tongue portion abuts against an inner upper edge of the U-shaped section.

### CROSS-REFERENCE TO RELATED PATENT APPLICATION

This application claims the benefit of priority to the U.S. Provisional Patent Application Ser. No. 63/537,853, filed on Sep. 12, 2023, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a card edge connector and a conductive terminal thereof, and more particularly to a card edge connector and a conductive terminal thereof capable of improving engagement strength.

### BACKGROUND OF THE DISCLOSURE

A card edge connector for used to connecting to a circuit board and allowing a corresponding mating card to be inserted therein to transmit data. In the related art, engagement between internal conductive terminals and insulating housing of the card edge connector is unstable. When the mating card is inserted inside the card edge connector, the conductive terminals are easily pushed by the mating card to shift out of the insulating housing, such that the electrical contact between the mating card and the conductive terminals is poor, thereby affecting the transmission of data.

Therefore, how to improve a structural design of the card edge connector and the conductive terminal thereof for overcoming the above-mentioned inadequacy has become an important issue to be addressed in the relevant art.

### SUMMARY OF THE DISCLOSURE

In response to the above-referenced technical inadequacy, the present disclosure provides a card edge connector and a conductive terminal, to address the technical problem of a conventionally unstable engagement between internal conductive terminals and insulating housing of the card edge connector.

In order to solve the above-mentioned problems, one of the technical aspects adopted by the present disclosure is to provide a card edge connector, which includes an insulative housing and a plurality of first conductive terminals. The insulative housing has a first side and a second side that are opposite to each other. The insulative housing includes a plurality of first retaining grooves on the first side thereof, each of the first retaining grooves includes a tongue portion therein, and the insulative housing includes a docking socket on the second side thereof. The plurality of first conductive terminals are inserted into the plurality of first retaining grooves, respectively. A part of each of the first conductive terminals forms a U-shaped section, and an inner lower edge of the U-shaped section includes a hook portion. When each of the first conductive terminals is inserted into a corresponding one of the first retaining grooves, the tongue portion is inset into an opening of the U-shaped section.

In order to solve the above-mentioned problems, another one of the technical aspects adopted by the present disclosure is to provide a conductive terminal, which is disposed inside an insulative housing of a card edge connector. The conductive terminal includes a first bending section and a U-shaped section. The first bending section has a first contact portion disposed at an inner surface of a front end. The U-shaped section is connected to a rear end of the first bending section at an intersection point, and an inner lower edge of the U-shaped section includes a hook portion. A distance between the intersection point and the first contact portion is smaller than a distance between the hook portion and the first contact portion.

Therefore, in the card edge connector and the conductive terminal thereof provided by the present disclosure, by virtue of “the conductive terminal including a U-shaped section, and an inner lower edge of the U-shaped section including a hook portion” and “a distance between the intersection point and the first contact portion is smaller than a distance between the hook portion and the first contact portion,” the engagement strength between the conductive terminal and the insulative housing can be improved.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of a card edge connector according to the present disclosure;

FIG. 2 is a schematic exploded view of the card edge connector according to the present disclosure;

FIG. 3 is a first schematic perspective view of an insulative housing according to the present disclosure;

FIG. 4 is a second schematic perspective view of the insulative housing according to the present disclosure;

FIG. 5 is a schematic view of a first conductive terminal according to a first embodiment of the present disclosure;

FIG. 6 is a schematic view of a first conductive terminal according to a second embodiment of the present disclosure;

FIG. 7 is a schematic perspective view of a grounding bracket according to the present disclosure;

FIG. 8 is a schematic perspective view of a side cover according to the present disclosure;

FIG. 9 is a schematic top view of the side cover, the grounding bracket, and the first conductive terminal according to the present disclosure; and

FIG. 10 is a schematic cross-sectional view taken along line X-X of FIG. 1.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### Embodiments

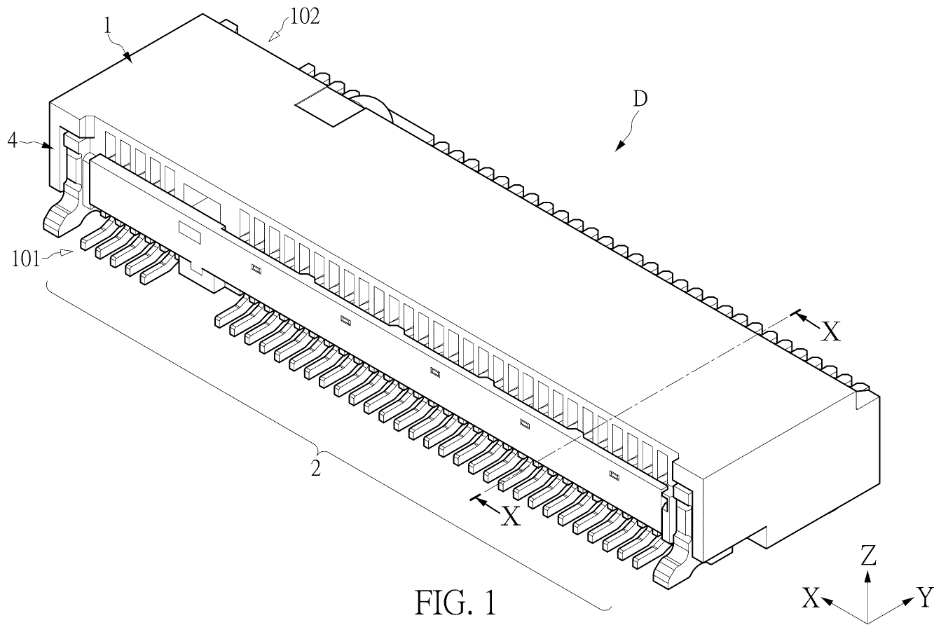

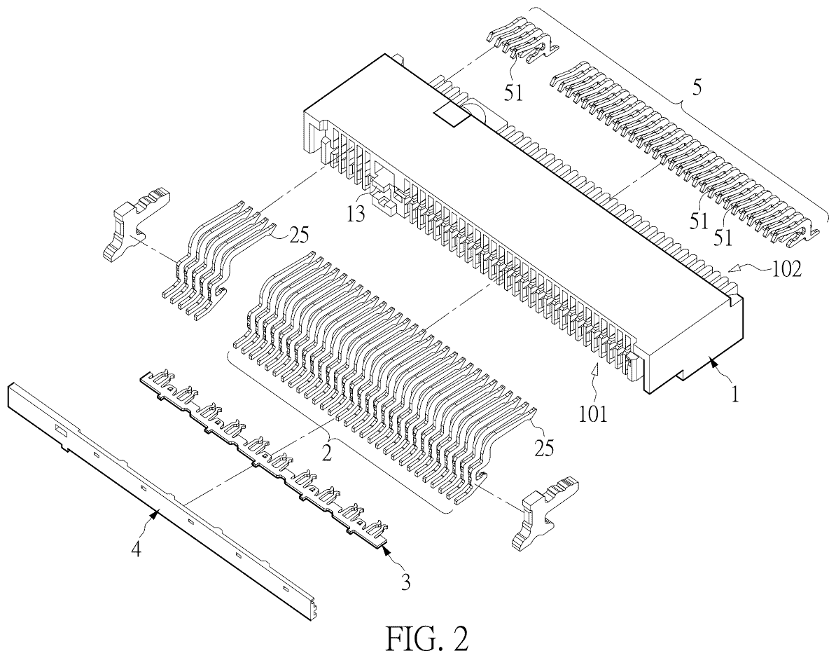

Reference is made to FIG. 1 and FIG. 2. The present disclosure provides a card edge connector D, which is disposed on a circuit board. The card edge connector D includes an insulative housing 1, a plurality of first conductive terminals 2, a grounding bracket 3, a side cover 4, and a plurality of second conductive terminals 5. The insulative housing 1 has a first side 101 and a second side 102 that are opposite to each other. The plurality of first conductive terminals 2, the grounding bracket 3, and the side cover 4 are disposed on the first side 101. The plurality of second conductive terminals 5 are disposed on the second side 102. The plurality of first conductive terminals 2 have a plurality of first contact portions 25, respectively. The plurality of second conductive terminals 5 have a plurality of second contact portions 51, respectively.

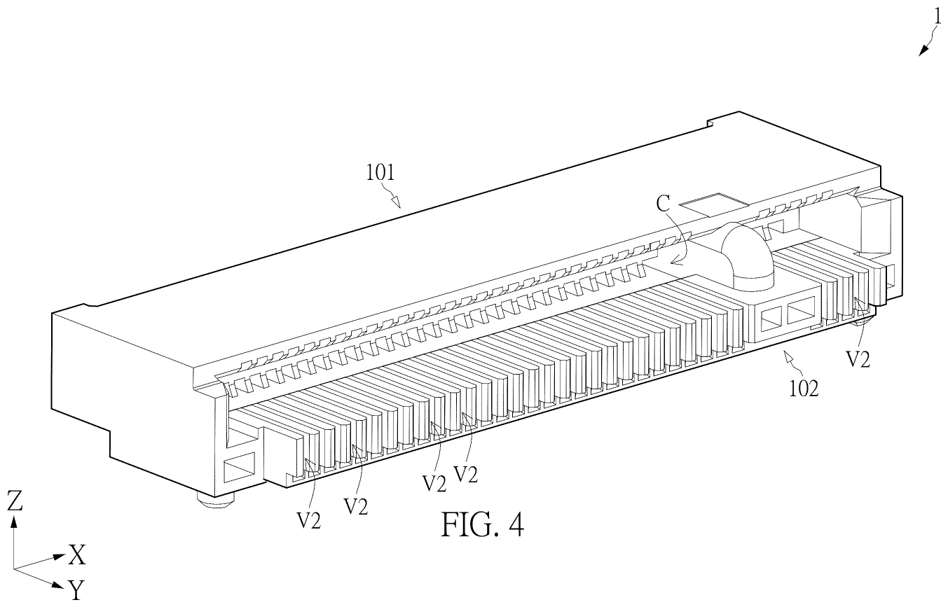

Reference is made to FIG. 2 to FIG. 4. The insulative housing 1 includes a plurality of first retaining grooves V1 on the first side 101, and a plurality of second retaining grooves V2 on the second side 102. The insulative housing 1 includes a docking socket C on the second side 102. The plurality of first conductive terminals 2 are respectively inserted into the plurality of first retaining grooves V1. The plurality of second conductive terminals 5 are respectively inserted into the plurality of second retaining grooves V2. An external mating card (not shown in the figures) can be inserted into the docking socket C along a docking direction (i.e., a negative Y-axis direction). The plurality of first conductive terminals 2 and the plurality of second conductive terminals 5 are arranged oppositely and staggeredly along a direction that is perpendicular to the docking direction. Similarly, the plurality of first contact portions 25 and the plurality of second contact portions 51 are arranged in a staggered arrangement, and the plurality of first contact portions 25 and the plurality of second contact portions 51 are respectively located and exposed on upper and lower sides of the docking socket C. When the external mating card is inserted into the docking socket C, the plurality of first contact portions 25 and the plurality of second contact portions 51 are in electrical contact with contact points (not shown in the figures) on the upper and lower sides of the mating card for signal transmission. In addition, each of the first retaining grooves V1 includes a tongue portion 11 therein.

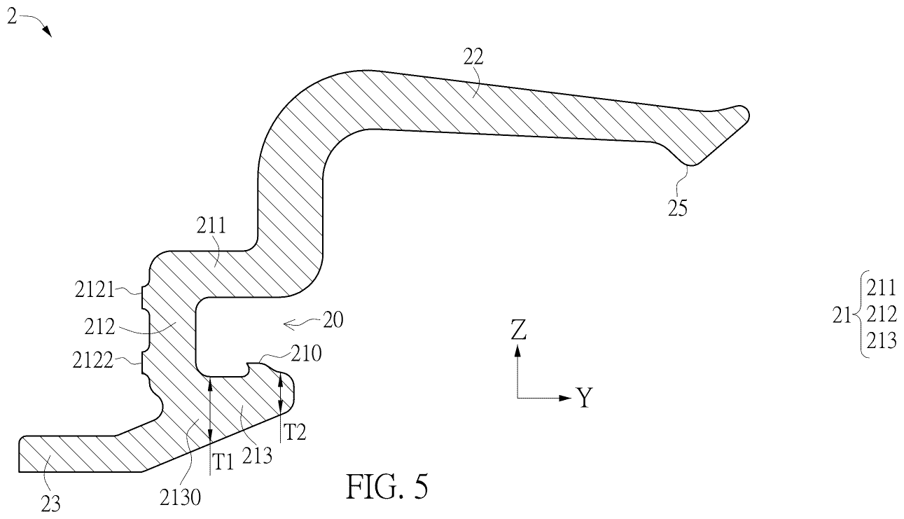

Reference is made to FIG. 5. One of the first conductive terminals 2 is taken as an example for illustration. The first conductive terminal 2 includes a U-shaped section 21, a first bending section 22, and a welding section 23. The U-shaped section 21 is formed by a part of each of the first conductive terminals 2. The first contact portion 25 is located at an inner surface of the front end of the first bending section 22. The U-shaped section 21 has an opening 20. An inner lower edge (i.e., an inner side of the opening 20) of the U-shaped section 21 includes a hook portion 210. The U-shaped section 21 further includes a first section 211, a second section 212, and a third section 213. The second section 212 is connected between the first section 211 and the third section 213, and the hook portion 210 is located on the third section 213.

When each of the first conductive terminals 2 is inserted into corresponding one of the first retaining grooves V1, only a part of the first bending section 22 including the first contact portion 25 and the welding section 23 are exposed. The welding section 23 is welded on the circuit board when the card edge connector D is disposed on the circuit board, such that the first conductive terminal 2 is electrically connected to the circuit board. A part of the first conductive terminal 2 located in the insulative housing 1, that is, the U-shaped section 21, is snap-fitted with the tongue portion 11 in the first retaining groove V1. The first bending section 22 and the first section 211 are connected at an intersection point. A distance along the Y-axis (docking direction) between the intersection point and the first contact portion 25 is smaller than a distance along the Y-axis between the hook portion 210 and the first contact portion 25 for improving a high-frequency resonance of the first conductive terminal 2. As shown in FIG. 5, a vertical projection of the hook portion 210 and a vertical projection of the first section 211 of the U-shaped section 21 mutually overlap along a vertical direction (i.e., a Z-axis direction).

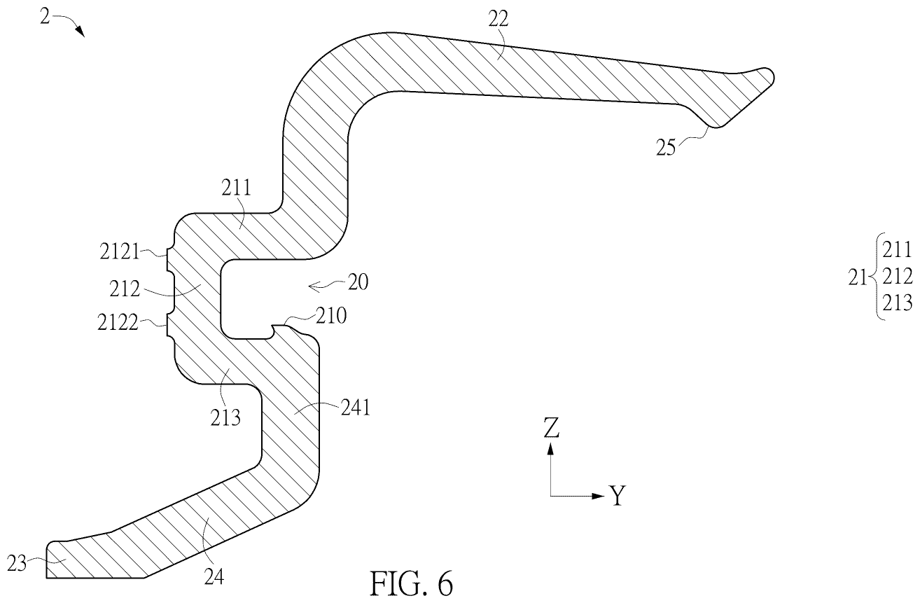

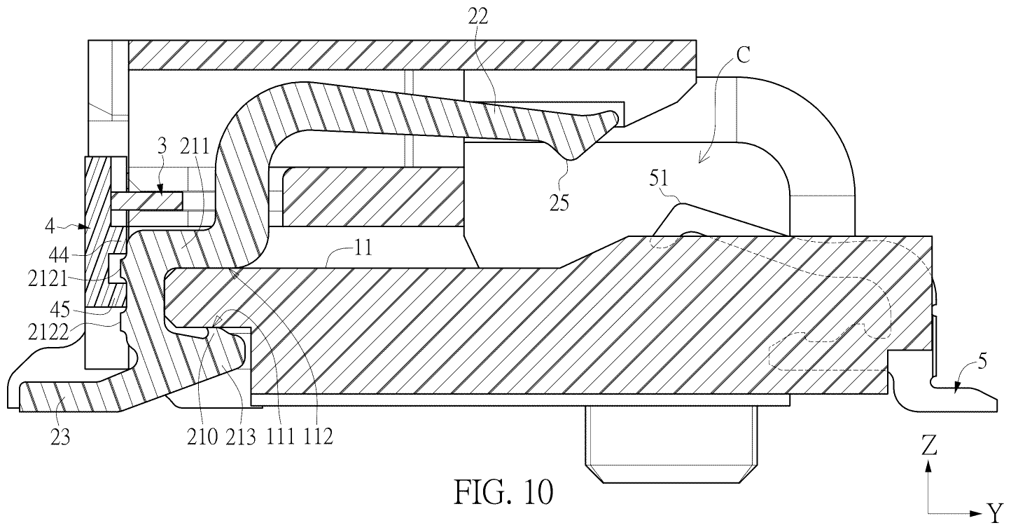

Reference is made to FIG. 6 and FIG. 10. When the tongue portion 11 is inset into the opening 20 of the U-shaped section 21, the hook portion 210 is applied to a torque by the first section 211 and the third section 213, to abut upwardly against a lower surface 111 of the tongue portion 11. Since the vertical projection of the hook portion 210 is exactly within an area of the first section 211, the first conductive terminal 2 is clamped from top and bottom by the U-shaped section 21 through the tongue portion 11 and fixed in the insulative housing 1.

The third section 213 of the U-shaped section 21 includes a root portion 2130. The third section 213 is connected to the second section 212 and the welding section 23 through the root portion 2130. A thickness of the third section 213 varies in different locations. As shown in FIG. 5, the thickness of the third section 213 gradually increases from the hook portion 210 to the root portion 2130. In other words, the thickness T1 of the third section 213 at the root portion 2130 is greater than the thickness T2 of the third section 213 at the hook portion 210. Through the structural design of the thickness of the third section 213 gradually increasing from the hook portion 210 to the root portion 2130, the structural strength of the bottom of the first conductive terminal 2 can be strengthened, and the normal force of the hook portion 210 upwardly abutting the tongue portion 11 can also be enhanced, so as to increase the engagement strength between the U-shaped section 21 and the tongue portion 11, and prevent the first conductive terminal 2 from loosening.

Reference is further made to FIG. 6. The first conductive terminal 2 shown in FIG. 6 (i.e., the second embodiment) has a structure similar to that of the first conductive terminal 2 shown in FIG. 5 (i.e., the first embodiment). In the second embodiment, in addition to the U-shaped section 21, the first bending section 22 and the welding section 23, the first conductive terminal 2 further includes a second bending section 24. A rear end of the first bending section 22 is connected to the first section 211 of the U-shaped section 21. The second bending section 24 is connected to the third section 213 of the U-shaped section 21. The welding section 23 is connected to the second bending section 24. Furthermore, the second bending section 24 includes a vertical section 241, and the vertical section 241 is connected to the third section 213 and located directly below the hook portion 210. Through the structural design of the vertical section 241, the structural strength of the bottom of the first conductive terminal 2 can be strengthened, and the normal force of the hook portion 210 upwardly abutting the tongue portion 11 can also be enhanced, so as to increase the engagement strength between the U-shaped section 21 and the tongue portion 11, and prevent the first conductive terminal 2 from loosening.

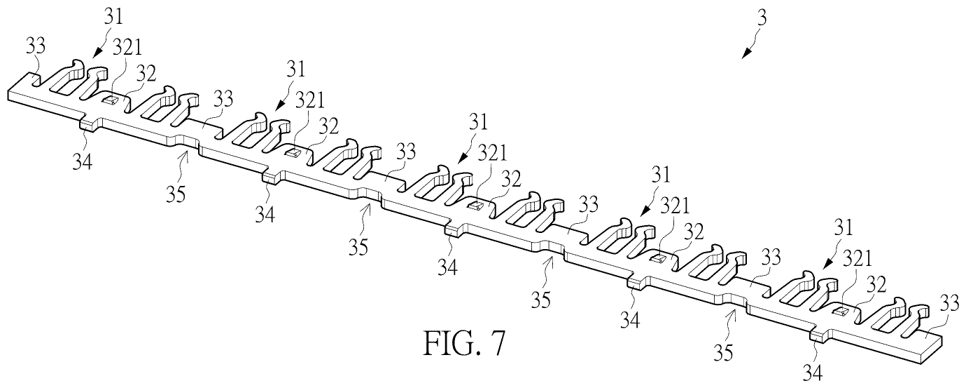

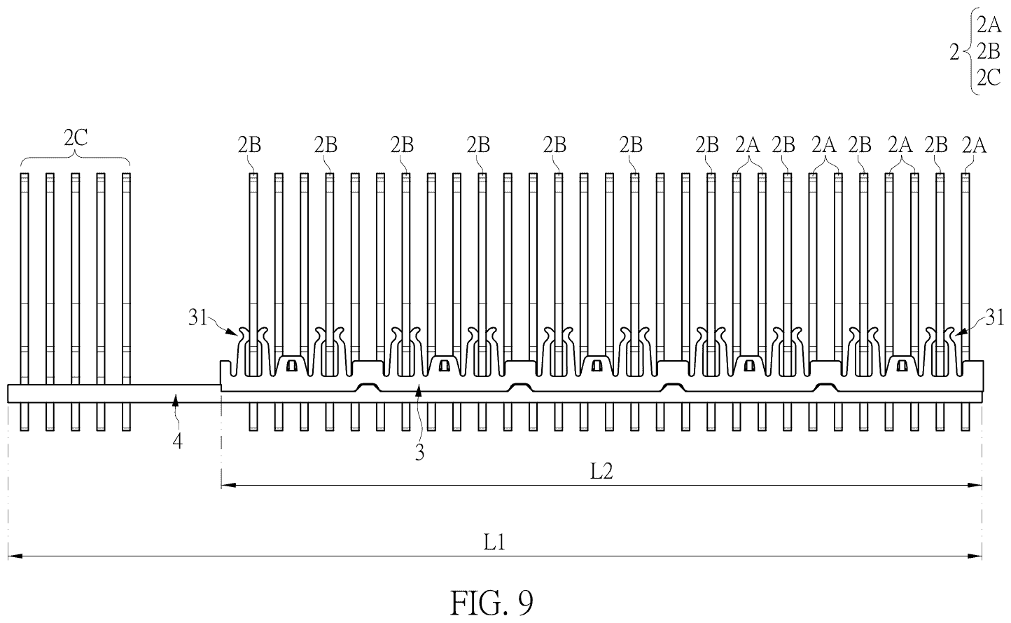

Reference is made to FIG. 7. The grounding bracket 3 includes multiple pairs of clamping arms 31, a plurality of first protruding portions 32, and a plurality of second protruding portions 33. The plurality of first protruding portions 32 and the plurality of second protruding portions 33 are arranged in a staggered arrangement with the multiple pairs of clamping arms 31. The plurality of first protruding portions 32 respectively have a plurality of interference bumps 321. Reference is further made to FIG. 7 and FIG. 9. The plurality of first conductive terminals 2 include a plurality of signal terminals 2A and a plurality of grounding terminals 2B. The plurality of signal terminals 2A and the plurality of grounding terminals 2B are arranged periodically, for example, in a periodic sequence of one ground terminal 2B and two signal terminals 2A (i.e., 2B-2A-2A). The multiple pairs of clamping arms 31 respectively clamp the plurality of grounding terminals 2B. Moreover, the grounding bracket 3 and the plurality of signal terminals 2A have no physical contact therebetween.

Reference is made to FIGS. 2, 3, and 7. The insulative housing 1 further includes a plurality of recessed portions 12 on the first side 101 thereof. When the grounding bracket 3 is disposed on the first side 101 of the insulative housing 1, the plurality of first protruding portions 32 and the plurality of second protruding portions 33 are snap-fitted with the plurality of recessed portions 12, and the plurality of interference bumps 321 interfere with the insulative housing 1, thereby enhancing the engagement strength between the grounding bracket 3 and the insulative housing 1.

Reference is further made to FIG. 7. The grounding bracket 3 further includes a plurality of third protruding portions 34 and a plurality of notches 35. The plurality of third protruding portions 34 and notches 35 and the plurality of first protruding portions 32 and second protruding portions 33 are disposed on opposite sides of the grounding bracket 3. Specifically, the plurality of third protruding portions 34 and the plurality of notches 35 are disposed at a long side of the grounding bracket 3, and the plurality of first protruding portions 32 and the plurality of second protruding portions 33 are disposed at another long side of the grounding bracket 3. The plurality of third protruding portions 34 respectively correspond to the plurality of first protruding portions 32, and the plurality of notches 35 respectively correspond to the plurality of second protruding portions 33.

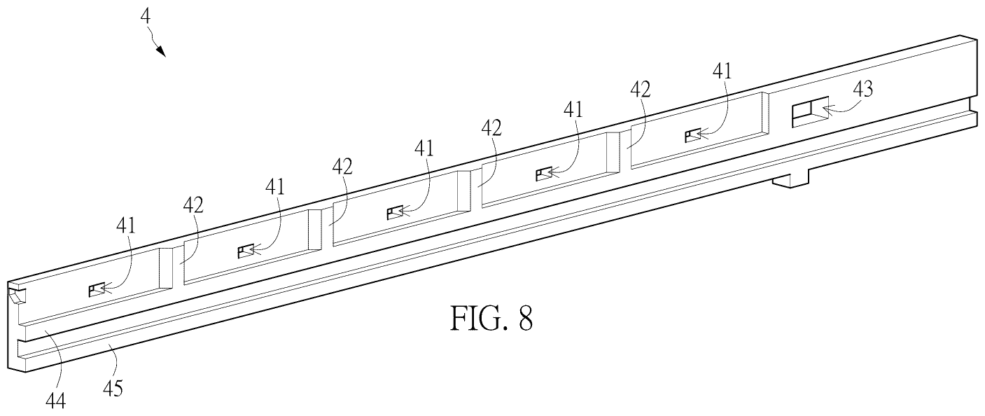

Reference is made to FIG. 8. The side cover 4 includes a plurality of positioning holes 41, a plurality of longitudinal ribs 42 arranged longitudinally, and a fixing hole 43. A thickness of the side cover 4 around the fixing hole 43 is greater than a thickness of the side cover 4 around the positioning holes 41. Reference is made to FIG. 9, in which a length L1 of the side cover 4 is greater than a length L2 of the grounding bracket 3. Reference is made to FIGS. 2, 7, and 9. The insulative housing 1 includes a fixing member 13 on the first side 101 thereof (shown in FIG. 2). The plurality of third protruding portions 34 of the grounding bracket 3 are snap-fitted with the plurality of positioning holes 41 of the side cover 4 (shown in FIG. 8). The plurality of longitudinal ribs 42 of the side cover 4 are snap-fitted with the plurality of notches 35 of the grounding bracket 3 (shown in FIG. 7), such that the side cover 4 further covers the grounding bracket 3 and is fixed on the grounding bracket 3 and the insulative housing 1 (shown in FIGS. 2 and 9), and achieves an effect of position limiting along an X-axis direction.

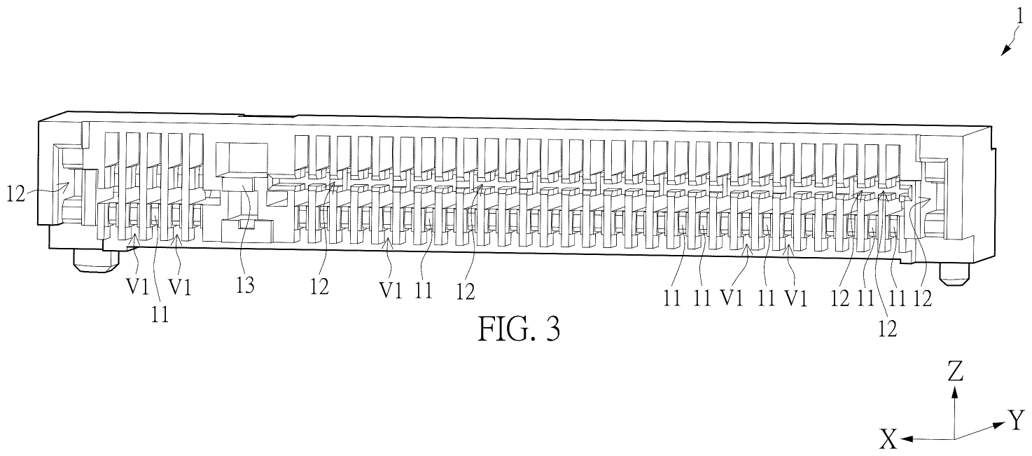

Reference is made to FIG. 3 and FIG. 9. The plurality of first conductive terminals 2 can include a plurality of power terminals 2C. The fixing member 13 divides the plurality of first retaining grooves V1 into two areas. The first retaining grooves V1 in one area is used for the insertion of the signal terminal 2A and the grounding terminal 2B, and the other area is used for the insertion of the power terminal 2C.

In the present disclosure, the side cover 4 is fixed to the insulative housing 1 through ultrasonic welding. As shown in FIGS. 1, 7, and 8, since the side cover 4 is relatively thick around the fixing hole 43, the fixing hole 43 of the side cover 4 interferes with the fixing member 13 of the insulative housing 1 through the engagement with each other, and other parts of the side cover 4 are fixed to the insulative housing 1 through ultrasonic welding. As shown in FIGS. 5, 8, and 10, the first conductive terminal 2 includes two protrusions 2121 and 2122 on the outside of the second section 212 of the U-shaped section 21, and the side cover 4 also includes two transverse ribs 44, 45. When the side cover 4 is fixed to the insulative housing 1, the side cover 4 abuts against the U-shaped section 21 of the first conductive terminal 2 through the two transverse ribs 44, 45. More precisely, the side cover 4 abuts against the second section 212 of the U-shaped section 21, to achieve an effect of position-limiting along the Z-axis direction.

### Beneficial Effects of the Embodiments

In the card edge connector and the conductive terminal thereof provided by the present disclosure, by virtue of “the conductive terminal including a U-shaped section 21, and an inner lower edge of the U-shaped section 21 including a hook portion 210” and “when the conductive terminal being disposed inside the insulative housing 1, a tongue portion 11 of the insulative housing 1 extending into an opening 20 of the U-shaped section 21, the hook portion 210 abutting against a lower surface of the tongue portion 11, and an upper surface of the tongue portion 11 abutting against an inner upper edge of the U-shaped section 21,” the engagement strength between the conductive terminal and the insulative housing 1 can be improved.

Moreover, a vertical projection of the hook portion 210 and a vertical projection of the first section 211 of the U-shaped section 21 mutually overlap along a vertical direction (i.e., a Z-axis direction). When the tongue portion 11 extends into the opening 20 of the U-shaped section 21, the hook portion 210 is applied to a torque by the third section 213, so as to abut upwardly against a lower surface 111 of the tongue portion 11. Since the vertical projection of the hook portion 210 is exactly within an area of the first section 211, a positive force provided by the hook portion 210 upwardly abutting against the tongue portion 11 pushes an upper surface 112 of the tongue portion 11 to abut against the inner upper edge (i.e., the first section 211) of the inner side of the U-shaped section 21. Thereby, the first conductive terminal 2 is clamped from top and bottom by the U-shaped section 21 through the tongue portion 11 and fixed in the insulative housing 1.

Moreover, in the conductive terminal provided by the present disclosure, through the structural design of the thickness of the third section 213 gradually increasing from the hook portion 210 to the root portion 213 (i.e., the thickness T1 of the third section 213 at the root portion 2130 is greater than the thickness T2 of the third section 213 at the hook portion 210), or through structural design of the vertical section 241, the structural strength of the bottom of the first conductive terminal 2 can be strengthened, and the positive force provided by the hook portion 210 upwardly abutting the tongue portion 11 can also be enhanced, so as to increase the engagement strength between the U-shaped section 21 and the tongue portion 11, and prevent the first conductive terminal 2 from loosening.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A card edge connector, comprising:
an insulative housing having a first side and a second side that are opposite to each other, wherein the insulative housing includes a plurality of first retaining grooves on the first side thereof, each of the first retaining grooves includes a tongue portion therein, and the insulative housing includes a docking socket on the second side thereof; and
a plurality of first conductive terminals being inserted into the plurality of first retaining grooves, respectively, wherein a part of each of the first conductive terminals forms a U-shaped section, and an inner lower edge of the U-shaped section includes a hook portion;
wherein, when each of the first conductive terminals is inserted into corresponding one of the first retaining grooves, the tongue portion is inset into an opening of the U-shaped section.

2. The card edge connector according to claim 1, wherein the U-shaped section further includes a first section, a second section and a third section, the second section is connected between the first section and the third section, the U-shaped section abuts against the upper surface of the tongue portion at the first section, the hook portion is located on the third section, and a vertical projection of the hook portion and a vertical projection of the first section overlap with each other.

3. The card edge connector according to claim 2, wherein the first conductive terminal further includes a first bending section and a welding section, the first bending section is connected to the first section, and the welding section is connected to the third section.

4. The card edge connector according to claim 3, wherein the third section includes a root portion, the third section is connected to the second section and the welding section through the root portion, and a thickness of the third section gradually increases from the hook portion to the root portion.

5. The card edge connector according to claim 3, wherein each of first conductive terminals have a first contact portion on the first bending section, the first bending section and the first section are connected at an intersection point, a distance along a docking direction of docking socket between the intersection point and the first contact portion is smaller than a distance along the docking direction between the hook portion and the first contact portion.

6. The card edge connector according to claim 2, wherein the first conductive terminal further includes a first bending section, a second bending section, and a welding section, the first bending section is connected to the first section, the second bending section is connected to the third section, the welding section is connected to the second bending section, and the second bending section includes a vertical section, and the vertical section is connected to the third section and located directly below the hook portion.

7. The card edge connector according to claim 1, further includes a grounding bracket disposed at the first side of the insulative housing, wherein the grounding bracket includes multiple pairs of clamping arms, the plurality of first conductive terminals include a plurality of signal terminals and a plurality of ground terminals, the plurality of signal terminals and the plurality of ground terminals are arranged periodically, and the multiple pairs of clamping arms clamp the plurality of ground terminals, respectively.

8. The card edge connector according to claim 7, wherein the grounding bracket further includes a plurality of first protruding portions and a plurality of second protruding portions, the plurality of first protruding portions and the plurality of second protruding portions are arranged in a staggered arrangement with the multiple pairs of clamping arms, the plurality of first protruding portions have a plurality of interference bumps, respectively, and the insulative housing further includes a plurality of recessed portions on the first side thereof; wherein, when the grounding bracket is disposed on the first side of the insulative housing, the plurality of first protruding portions and the plurality of second protruding portions are snap-fitted with the plurality of recessed portions, and the plurality of interference bumps interfere with the insulative housing.

9. The card edge connector according to claim 8, wherein the grounding bracket further includes a plurality of third protruding portions and a plurality of notches, wherein the third protruding portions and the notches, and the first protruding portions and the second protruding portions, are disposed on opposite sides of the grounding bracket, and wherein the plurality of third protruding portions respectively correspond to the plurality of first protruding portions, and the plurality of notches respectively correspond to the plurality of second protruding portions.

10. The card edge connector according to claim 9, further comprising a side cover, wherein the side cover is disposed on the first side of the insulative housing, a length of the side cover is greater than a length of the grounding bracket, the side cover covers and is fixed on the grounding bracket, the side cover includes a plurality of positioning holes and a plurality of ribs, the plurality of third protruding portions are snap-fitted with the plurality of positioning holes, and the plurality of ribs are snap-fitted with the plurality of notches.

11. The card edge connector according to claim 10, wherein the side cover further includes a fixing hole, the insulative housing includes a fixing member on the first side thereof, and the fixing member is snap-fitted with the fixing hole.

12. The card edge connector according to claim 11, wherein a thickness of the side cover around the fixing hole is greater than a thickness of the side cover around the positioning hole.

13. The card edge connector according to claim 10, wherein the side cover is fixed to the insulative housing through ultrasonic welding.

14. The card edge connector according to claim 1, further comprising a plurality of second conductive terminals disposed on the second side, wherein a plurality of first conductive terminals has a plurality of first contact portions, the plurality of second conductive terminals has a plurality of second contact portions, and the plurality of first contact portions and the plurality of second contact portions are respectively located and exposed on upper and lower sides of the docking socket.

15. The card edge connector according to claim 14, wherein the plurality of first contact portions and the plurality of second contact portions are arranged staggeredly.

16. A conductive terminal being disposed inside an insulative housing of a card edge connector, the conductive terminal comprising:
a first bending section, having a first contact portion at an inner surface of a front end; and
a U-shaped section connected to a rear end of the first bending section at an intersection point, an inner lower edge of the U-shaped section including a hook portion;
wherein a distance between the intersection point and the first contact portion is smaller than a distance between the hook portion and the first contact portion.

17. The conductive terminal according to claim 16, wherein the U-shaped section further includes a first section, a second section and a third section, the second section is connected between the first section and the third section, the U-shaped section abuts against the upper surface of the tongue portion at the first section, the hook portion is located on the third section, and a vertical projection of the hook portion and a vertical projection of the first section overlap with each other.

18. The conductive terminal according to claim 17, further comprising a welding section, the first bending section is connected to the first section, and the welding section is connected to the third section.

19. The conductive terminal according to claim 18, wherein the third section includes a root portion, the third section is connected to the second section and the welding section through the root portion, and a thickness of the third section gradually increases from the hook portion to the root portion.
